(19) United States
(12) Patent Application Publication
(10) Pub. No.: US 2020/0332026 A1
(43) Pub. Date: Oct. 22, 2020

(54) CHEMICAL PROCESSES AND COMPOSITIONS FOR MECHANICALLY STABILIZING CELLULOSE-LIGNIN BASED ARTIFACTS

(71) Applicant: Lawrence Livermore National Security, LLC, Livermore, CA (US)

(72) Inventor: James Lewicki, Oakland, CA (US)

(21) Appl. No.: 16/754,358

(22) PCT Filed: Nov. 13, 2018
(86) PCT No.: PCT/US2018/060843

§ 371 Date: Apr. 7, 2020

Related U.S. Application Data
(60) Provisional application No. 62/585,898, filed on Nov. 14, 2017.

(51) Int. Cl. C08B 15/10; C08G 77/12; C08L 97/00; C08L 1/02; C08L 83/04; C08H 7/00; C08G 77/08

(52) U.S. Cl. CPC C08B 15/10; C08G 77/12; C08L 97/005; C08G 77/08; C08L 83/04; C08H 6/00; C08L 1/02

(57) ABSTRACT

In one inventive concept, a product for modifying a cellulose-lignin material with siloxane includes a mixture having a siloxane species, a metal catalyst, and a nonpolar solvent. The mixture is operative to modify a cellulose-lignin material with siloxane upon wetting of the cellulose-lignin material with the mixture and subsequent drying of the cellulose-lignin material. In another inventive concept, a product includes a siloxane-modified cellulose-lignin material having a cellulose-lignin network and a network of siloxane in cross-linking bridges in the cellulose-lignin network.

The United States Government has rights in this invention pursuant to Contract No. DE-AC52-07NA27344 between the United States Department of Energy and Lawrence Livermore National Security, LLC for the operation of Lawrence Livermore National Laboratory.

### FIELD OF THE INVENTION

The present invention relates to stabilizing cellulose-lignin based material, and more particularly, this invention relates to a chemical processes and compositions for mechanically stabilizing cellulose-lignin based conservation artifacts.

### BACKGROUND

The study of the degradation of cultural and historical artifacts includes study of ways to preserving artifacts that are subject to age-related degradation processes, for example, paper artifacts disintegrating over time. Artifacts of cultural and historical significance susceptible to age-related degradation may include but are not limited to museum items, buildings, manuscripts, art items, forensic collections, natural product collections, etc. In particular, cellulose-lignin based cultural artifacts are susceptible to age-related degradation, especially where they are paper based materials. Natural polymer-derived materials based on cellulose-lignin are vulnerable to thermodynamically driven thermal, chemical, and biological stressors acting on the material over time resulting in aging and degradation of the material. For example, paper is subject to thermal/thermoxidative/photo degradation of the cellulose and lignin polymers as well as acid catalyzed hydrolysis of the cellulose chains. These processes lead to discoloration of the paper, changes in the mechanical properties, the release of volatile organic compounds (VOCs) (e.g., typically associated with an old book odor), etc. Moreover, in the case of advanced hydrolytic scission of cellulose, paper may lose specific mechanical properties as a result of a decrease in the average molar mass of the cellulose polymers.

Paper- or wood-based artifacts of cultural or historical significance, e.g. a manuscript collection, that undergo age-related degradation become less useable as a resource. Moreover, the library housing degraded artifacts tends to experience an increase in the costs of handling/storage and loss of the resources through disintegration of the paper- and wood-based artifacts. Thus, it would be desirable to limit, or prevent, age-related degradation of paper- or wood-based artifacts.

The cellulosic components of paper seem to be the most vulnerable components of artifacts. A simple, low risk, least invasive strategy is to control the environment of the artifacts (i.e. environmental control). By storing the artifacts in low oxygen, low temperature, controlled light, and controlled humidity with a high atmosphere exchange rate, the degradation processes can be minimized by, e.g. reducing oxidation, reducing thermal/hydrolytic degradation, preventing the build-up of reactive volatile materials evolved from the paper, reducing autocatalysis degradation, etc. However, environmental control is expensive in terms of infrastructure and upkeep, and may limit accessibility of the historical/cultural resource to the public, researchers and conservators.

Another strategy to prevent aging-related degradation of paper material includes quenching acidic reactive species in the paper materials by a solvent-mediated technique to remove pro-degradants (e.g. basic washing and impregnation of paper materials with basic solvent, diluted solutions of bicarbonate, etc.). However, this strategy may further damage the material, for example, inducing unexpected degradation processes, discoloring or bleaching the inks/colorants, increasing the toxicity of the artifact, etc.

Recent studies of mechanical preservation of paper by polymer encapsulation have been controversial. Although lamination of paper between bonded polyolefin or cellulose acetate and adhesive base layers may mechanically stabilize manuscripts and act as a barrier layer to arrest the ingress of potential environmental pro-degradants such as oxygen and sulfur dioxide, the lamination negatively alters the handle-ability, tactile response, and appearance of the manuscripts. Moreover, the encapsulation layer traps and concentrates internally produced degradants (for example, acetic acid) within the paper, thereby critically accelerating the degradation of the manuscript within the laminate. Furthermore, the lamination itself is subject to discoloration and degradation processes; and the process is irreversible such that the lamination cannot be removed without severely damaging the paper itself. A similar example is the common fix of applying “sticky tape” to repair physical damage or protect the surface of a page in a book. After only a few years, the tape repair will have yellowed significantly and the adhesive failed as a result of thermoxidative degradation thereby leaving a permanent and undesirable residue on the surface of the paper.

As the cellulose-lignin structure degrades, the material becomes brittle. It would be desirable to develop an affordable, active process of preserving and/or repairing the cellulose-lignin polymer structure so as to preserve paper- or wood-based material artifacts and prevent age-related degradation that would retain the integrity and handle-ability of the artifact for public access.

### SUMMARY

In one inventive concept, a product for modifying a cellulose-lignin material with siloxane includes a mixture having a siloxane species, a metal catalyst, and a nonpolar solvent. The mixture is operative to modify a cellulose-lignin material with siloxane upon wetting of the cellulose-lignin material with the mixture and subsequent drying of the cellulose-lignin material.

In another inventive concept, a method for modifying a cellulose-lignin material with siloxane includes exposing the cellulose-lignin material to a mixture comprising a siloxane species, a metal catalyst, and a nonpolar solvent to penetrate the cellulose-lignin material with the siloxane species, removing the cellulose-lignin material penetrated with the siloxane species from the mixture, and drying the cellulose-lignin material penetrated with the siloxane species. The cellulose-lignin material is modified with siloxane upon drying thereof.

In yet another inventive concept, a product includes a siloxane-modified cellulose-lignin material having a cellulose-lignin network and a network of siloxane in cross-linking bridges in the cellulose-lignin network.

Other aspects and advantages of the present invention will become apparent from the following detailed description, which, when taken in conjunction with the drawings, illustrate by way of example the principles of the invention.

### BRIEF DESCRIPTION OF THE DRAWINGS

FIG. 1 is a flow chart of a method according to one inventive concept.

FIG. 2A is a schematic drawing of generalized structures of lignin and cellulose.

FIG. 2B is a schematic drawing of hydrolyzed cellulose chains.

FIG. 2C is a schematic drawing of the formation of a siloxane-modified cellulose-lignin material, according to one inventive concept.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

The following description discloses several preferred inventive concepts of chemical processes and compositions for mechanically stabilizing cellulose-lignin based artifacts and/or related systems and methods.

In one general inventive concept, a product for modifying a cellulose-lignin material with siloxane includes a mixture having a siloxane species, a metal catalyst, and a nonpolar solvent. The mixture is operative to modify a cellulose-lignin material with siloxane upon wetting of the cellulose-lignin material with the mixture and subsequent drying of the cellulose-lignin material.

In another general inventive concept, a method for modifying a cellulose-lignin material with siloxane includes exposing the cellulose-lignin material to a mixture comprising a siloxane species, a metal catalyst, and a nonpolar solvent to penetrate the cellulose-lignin material with the siloxane species, removing the cellulose-lignin material penetrated with the siloxane species from the mixture, and drying the cellulose-lignin material penetrated with the siloxane species. The cellulose-lignin material is modified with siloxane upon drying thereof.

In yet another general inventive concept, a product includes a siloxane-modified cellulose-lignin material having a cellulose-lignin network and a network of siloxane in cross-linking bridges in the cellulose-lignin network.

A list of acronyms used in the description is provided below.

| | |
|---|---|
| C. | Celsius |
| DMS | dimethylsiloxane |
| DPS | diphenylsiloxane |
| g | grams |
| kDa | kilodalton |
| M | molar |
| PDMS | polydimethylsiloxane |
| ppm | parts per million |
| VOC | volatile organic compounds |
| Wt % | weight percent |

Cellulose is a primary component of paper- and wood-based artifacts. Various inventive concepts described herein involve chemical processes and/or materials for repairing the cellulose of paper- and wood-based materials. Various inventive concepts described herein involve direct chemical modification of cellulose, and to a lesser degree the lignin of paper- and wood-based materials, that may optionally include the formation of a low crosslink density interpenetrating co-network of siloxane chains within the cellulose-lignin matrix as a means of modifying and improving the mechanical properties of the original cellulose-lignin based artifact, in other words, chemically “stitching” the degrading cellulose-lignin-based material back together. Inventive concepts described herein may provide benefit to all cellulose-lignin based materials, and are especially useful when applied to a range of cellulose-lignin based materials including, but not limited to wood, paper, papier mäché, textiles, etc.

In one inventive concept, a product for modifying a cellulose-lignin material with siloxane includes a mixture having a siloxane species, a metal catalyst, and a nonpolar solvent. The mixture has ratios of these components in ranges that are operative to modify a cellulose-lignin material with siloxane upon wetting of the cellulose-lignin material with the mixture and subsequent drying of the cellulose-lignin material. In some approaches, the material may be a cellulose-lignin based material.

In some approaches, an amount of the siloxane species of the mixture may be in a range of about 0.1 wt % to about 10 wt % of a total weight of the mixture.

In some approaches, the siloxane species of the mixture includes a multi-functional siloxane and siloxane oligomers. According to an exemplary inventive concept, a composition of siloxanes includes be 80-100 wt % of a multifunctional siloxane, 0-10 wt % of a multifunctional silane oligomer, and 0-50 wt % of a bi-functional oligomers or macromonomers, e.g., having two reactive groups at the end of the chain. An exemplary example of a multi-functional siloxane includes Tetrakis(dimethylsiloxy)silane. In some approaches, the amount of Tetrakis(dimethylsiloxy)silane may be in a range of about 80 weight % to about 100 weight % of total weight of the mixture. In other approaches, the amount of Tetrakis(dimethylsiloxy)silane may be in a range of about 85 weight % to about 95 weight % of total weight of the mixture.

In one approach, a composition of silane and siloxane oligomers may include 80-100% Tetrakis(dimethylsiloxy)silane, 0-10% polymethylhydrosiloxane oligomers, and 0-15 wt % bis-silane functional siloxane oligomers. Further examples of multifunctional silane, and siloxane oligomers/macromonomers include methylhydrocyclosiloxane mixtures ((CH₃HSiO)₃₋₅), methylhydrosiloxane-dimethylsiloxane copolymers with methylhydrosiloxane content from 1-99 mol % and molar mass ranges of ˜0.1-400 kDa, 1,3-dephenyltetrakis(dimethylsiloxy)disiloxane, tetrakis(1,1,3,3-tetramethyldisiloxanyl) orthosilicate, bis(3,3-dimethyl-1,1-diphenyldisiloxanyl) bis(1,1,3,3-tetramethyldisiloxanyl) orthosilicate, silane M/Q resins of various molar mass and silane content, poly(methylhydrosiloxane)-co-polydimethylsiloxane of molar masses ranging from 0.1 to 200 kDa, etc.

In some approaches, exemplary examples of siloxane oligomers of the siloxane species include a polymethylhydrosiloxane oligomer, a bis-silane functional siloxane oligomer, etc.

In some approaches, an amount of polymethylhydrosiloxane oligomer of the siloxane oligomers may be in a range of greater than 0 weight % to about 10 weight % of total weight of the mixture. In some approaches, an amount of bis-silane functional siloxane oligomers may be in a range of greater than 0 weight % to about 50 weight % of total weight of the mixture. In other approaches, the amount of bis-saline functional siloxane oligomers may be in a range of greater than 0 wt % to about 30 wt % of total weight of the mixture.

Further examples of bi-functional silane oligomers/macromonomers include hydride terminated poly(dimethyl)-co-(methylhydro)-co-(diphenyl)siloxane and DPS-DMS homopolymer analogues with diphenyl content from 0-100 mol % with molar mass range from ˜0.1-400 kDa.

In some approaches, exemplary examples of a nonpolar solvent of the mixture may be toluene, chloroform, etc.

In some approaches, the amount of metal catalyst in the mixture may be in a range of about 10 ppm to about 100 ppm. An exemplary example of a metal catalyst is a Karstedt's catalyst.

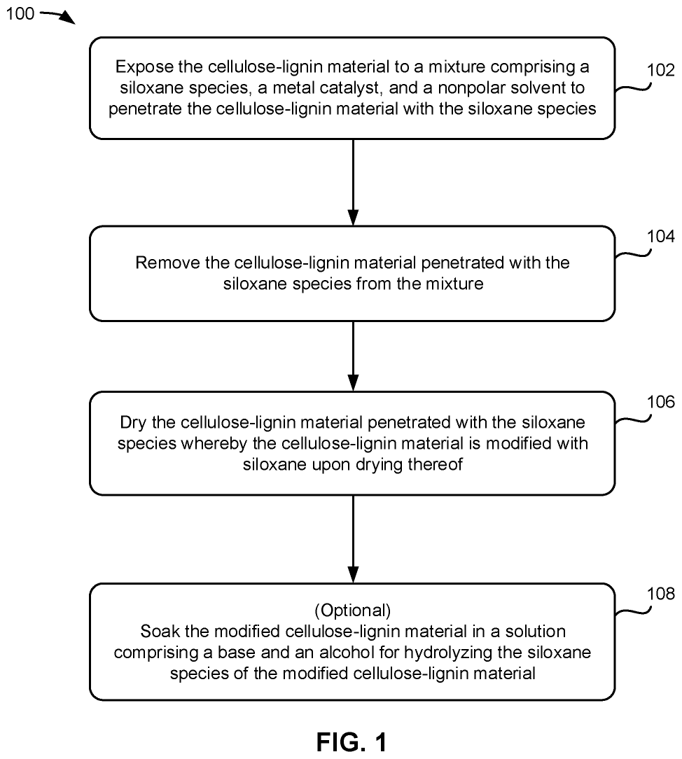

FIG. 1 shows a method 100 for forming a polymeric network support for cellulose-lignin based material, in accordance with one inventive concept. As an option, the present method 100 may be implemented to construct structures such as those shown in the other FIGS. described herein. Of course, however, this method 100 and others presented herein may be used to form structures which may or may not be related to the illustrative inventive concepts listed herein. Further, the methods presented herein may be carried out in any desired environment. Moreover, more or less operations than those shown in FIG. 1 may be included in method 100, according to various inventive concepts. It should also be noted that any of the aforementioned features may be used in any of the inventive concepts described in accordance with the various methods.

Step 102 includes exposing the cellulose-lignin material to a mixture comprising a siloxane species, a metal catalyst, and a nonpolar solvent to penetrate the cellulose-lignin material with the siloxane species. In some approaches, the composition of siloxanes and siloxane oligomers may have a total weight (wt) fraction of dissolved siloxane species in a range of 0.1-10 wt %.

In some approaches, interpenetrating networks of polysiloxanes may be formed via acyl chemistry, thiolene chemistry, amine-epoxide/direct epoxide chemistry, urethane isocyanate chemistry or acrylate chemistry etc. In some approaches, the siloxane core/backbone/chain may be functionalized with the specific chemical moieties specified above, at a reactive functionality sufficient to induce polymerization into a polymer network under the influence of heat or radiation. In some approaches, in the presence of appropriate catalysts, metal-mediated hydrosilylation may be employed directly for the synthesis of silicone based networks. In other approaches, in the presence of appropriate catalysts, direct silanol condensation chemistry may be employed directly for the synthesis of silicone based networks. In some approaches, the siloxane species include silicone, polymerized siloxanes, polysiloxanes having pure DMS and/or pure DPS in mixed co-polymer composition, etc.

In some approaches of the method, the metal catalyst initiates a transition metal-mediated hydrosilylation reaction between the siloxane species and the cellulose-lignin material. In some approaches, the amount of metal catalyst in the mixture may be in a range of about 5 parts per million (ppm) to about 400 ppm. In some approaches, the amount of metal catalyst in the mixture may be in a range of about 10 ppm to about 100 ppm. In other approaches, the amount of metal catalyst in the mixture may be in a range of about 20 ppm to about 80 ppm. In a preferred approach, the nominal loading of metal catalyst for the reaction is 40 ppm. Higher levels of catalyst greater than 400 ppm may generate undesirable side reactions and excessive heat. Lower levels of catalyst, between 1 and 5 ppm may be slow in the absence of heat to drive the reaction.

In some approaches, the metal catalyst is a Karstedt's catalyst. In other approaches using direct silanol condensation or silane co-reactive with cellulose OH functionality, a metal catalyst may be a tin (Sn) catalyst such as tin(II) 2-ethylhexanoate or dibutyltin dilaurate. In such approaches, the concentration of metal catalyst may be in a range of 0.1 wt % to 6 wt % of total mixture.

In yet other approaches, organo-platinum catalysts may catalyze both hydrosilylation crosslinking reactions for the formation of interpenetrating networks and reactions of silane functional species with OH functionality on cellulose-lignin to form a co-network structure. Exemplary organo-platinum catalysts may include platinum-cyclovinylmethyl-siloxane complexes dissolved in siloxane oligomers, dimethylplatinum(II) cyclooctadiene complex, platinum-[1,3-bis(cyclohexyl)imidazol-2-ylidene]-[divinyltetramethyldisiloxane] complex, platinum-divinyltetramethyldisiloxane complex, 2.0% Pt in vinyl terminated PDMS, etc.

In yet other approaches, metal-based catalysts may include chloroplatinic acid, ruthenium(II) cyclooctadiene bis(2,2,6,6,-tetramethyl-3,5,heptanedionate), ruthenium(III) 2,4-pentanedionate, ruthenium(III) 2,2,6,6-tetramethyl-3,5-heptanedionate, etc.

In some approaches, a mixture of multi-functional (silane functional) siloxanes and siloxane oligomers may be dissolved in a solution of a non-polar organic solvent and a metal/metal-organic catalyst. In some approaches, a non-polar organic solvent may be chloroform, toluene, etc. In some approaches, the addition of a non-polar solvent or polar solvent may depend on solubility of the siloxane, siloxane oligomers, and catalysts in the non-polar solvent.

In some approaches of step 102, the exposing may be applying the mixture to the cellulose-lignin material, for example but not meant to be limiting, by brushing (e.g. painting), dropping, spraying, etc. In other approaches, of step 102, the exposing may be soaking the cellulose-lignin material in a bath of the mixture.

Various approaches described herein utilize transition metal-mediated hydrosilylation coupling chemistry to covalently react hydroxyl functionalities on the cellulose and lignin polymers with small molecule and oligomeric multi-silane functional siloxane species. The effect of this coupling provides new and additional crosslinks and linkages between cellulose and lignin fragments to effectively repair degradation-induced chain scissions and provide chemical crosslinking within the material. Various processes described herein mechanically reinforce the original polymer cellulose-lignin structure and mitigate the effects of degradation processes, for example, cellulosic hydrolytic scission. Moreover, transition metal-mediated hydrosilylation coupling chemistry may occur at mild temperatures, for example, room temperature.

The coupling chemistry of transition metal-mediated hydrosilylation may include covalently reacting hydroxyl functionalities on the cellulose and lignin polymers with small molecule and oligomeric multi-silane functional siloxane species. The coupling may provide crosslinks and additional linkages (e.g., bridging) between cellulose and lignin fragments to repair degradation-induced chain scissions. Moreover, coupling may mechanically reinforce the cellulose-lignin system and mitigate the effects of degradation, for example, cellulosic hydrolytic scission. In some approaches, a modification by methods described may re-polymerize the cellulose-lignin structure, and in so doing, regain original mechanical properties of the cellulose-lignin polymer in the paper- or wood-based material.

In an exemplary inventive concept, processed, printed paper may be treated with a platinum hydrosilylation coupling reaction. In other approaches, alternate catalysts, e.g. Rh complexes, and alternate coupling chemistries, e.g. isocyanate functional siloxanes, may be used. In some approaches, a range of cellulose-lignin-based materials e.g., wood, cotton, etc. may be the target of the modification strategy.

In some inventive concepts, the modified cellulose material as described may be hydrophobic.

The procedure of applying the mixture of siloxane-metal catalyst in nonpolar solvent to the target cellulose-lignin-based material may be performed using any method. According to various approaches, the procedure of applying the mixture may be carried out as a dip application, spray application, brush application, etc.

In some approaches, the coupling may occur at moderately elevated temperatures, e.g., above room temperature. In some approaches, the solvent may be removed during the coupling reaction. In other approaches, cellulose-lignin material may be soaked in a bath of siloxane mixture solution at ambient temperature for duration of time to cycling to ensure the penetration of the reagent solution into the cellulose fibers. In some approaches, the temperature of the bath may be room temperature (e.g. in a range of about 20° C. to about 25° C.) for an effective amount of time (e.g. about 1-5 hours with pressure) to allow penetration of the siloxane mixture into the cellulose-lignin material.

In one inventive concept, additional oligomeric silane and vinyl functional oligomers may be added to the solution, in sufficient quantities to form a contiguous and interpenetrating co-network within the paper matrix for additional reinforcement. The applications of such extreme modification may be limited to extreme cases of remediation and restoration, as the tactility and appearance of the paper are altered significantly with this additional step.

In some approaches, an inorganic filler may be added to the mixture of step 102. In some approaches, the amount of inorganic filler added to the mixture may be in a range of about 1 wt % to about 10 wt % of the total weight of the mixture. In one exemplary approach, an inorganic filler includes an inorganic microfiller, for example, fumed silica microaggregates added in a concentration in a range of 1-10 wt % of total mixture in order to mitigate index matching induced transparency of the paper with the addition of the co-network component.

In some inventive concepts an additional layer of silicone may be added to the original damaged cellulose-lignin polymer. An additional layer of silicone (e.g., oligomeric silane, oligomeric siloxane, etc.) may provide diffuse-ability to the original cellulose-lignin polymer, allowing small molecules such as oxygen, carbon monoxide, etc. to diffuse in and out. The paper with the layer of silicone may then still breathe.

Step 104 includes removing the cellulose-lignin material penetrated with the siloxane species from the mixture.

Step 106 includes drying the cellulose-lignin material penetrated with the siloxane species whereby the cellulose-lignin material is modified with siloxane upon drying thereof. In some approaches, the treated-cellulose-lignin material may be removed from the siloxane mixture solution bath and dried to complete the modification process. In one exemplary approach, for example, the treated paper may be hung in a forced convection oven and held at a temperature of 50-110° C. for a period of 1-12 hours.

In some approaches, the extent of siloxane modification may be tunable based on the degree of reinforcement/repair that the cellulose-lignin material may need. In some inventive concepts, the siloxane modification (i.e. penetration of siloxane into the cellulose-lignin material) may not significantly inhibit transport of gas, mobile VOCs or water vapor into our out of the cellulose-lignin material (e.g. paper). Moreover, the siloxane modification may not induce desiccation nor trap a significant amount of reactive, pro-degradant species within the cellulose-lignin material substrate.

In some inventive concepts, the formation of a low crosslink density interpenetrating co-network of siloxane chains within the cellulose-lignin matrix may further modify and improve the mechanical properties of cellulose-lignin based material. For example, the strength of the cellulose-lignin based material may be improved. Moreover, the cellulose-lignin based material may be less likely to break, crumble, etc. upon being bent or pressed.

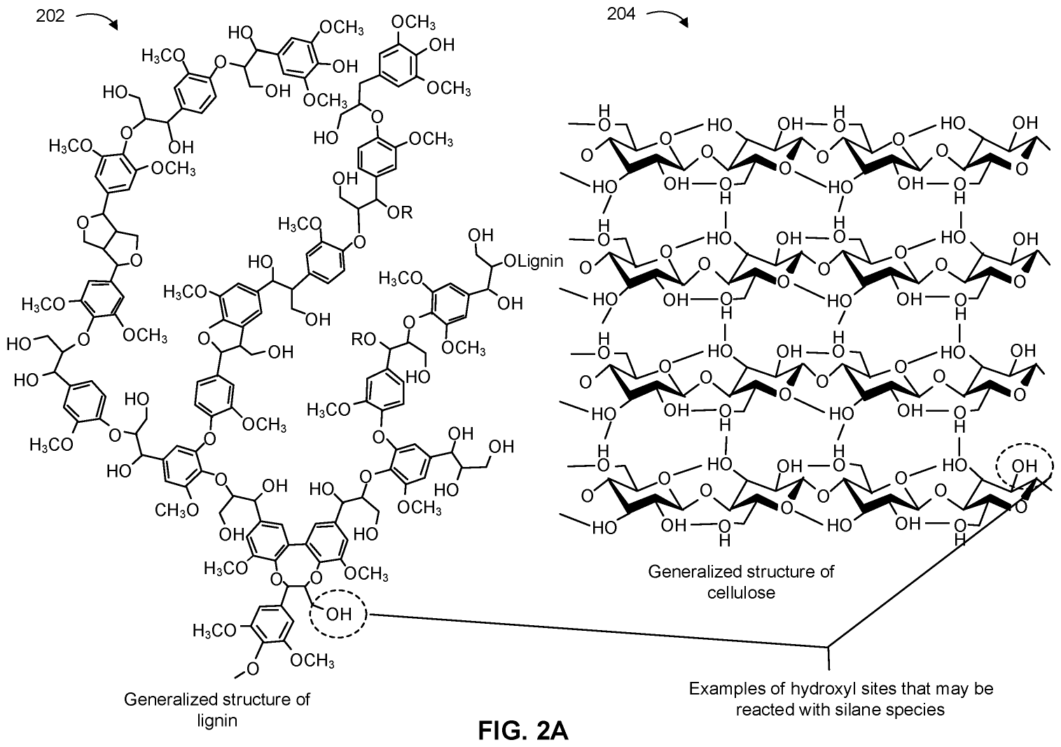

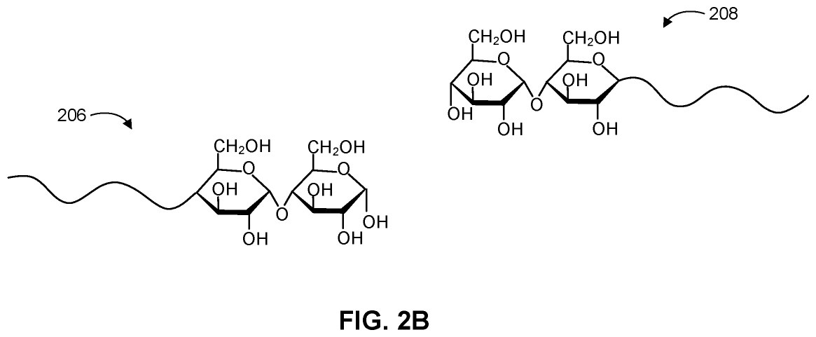

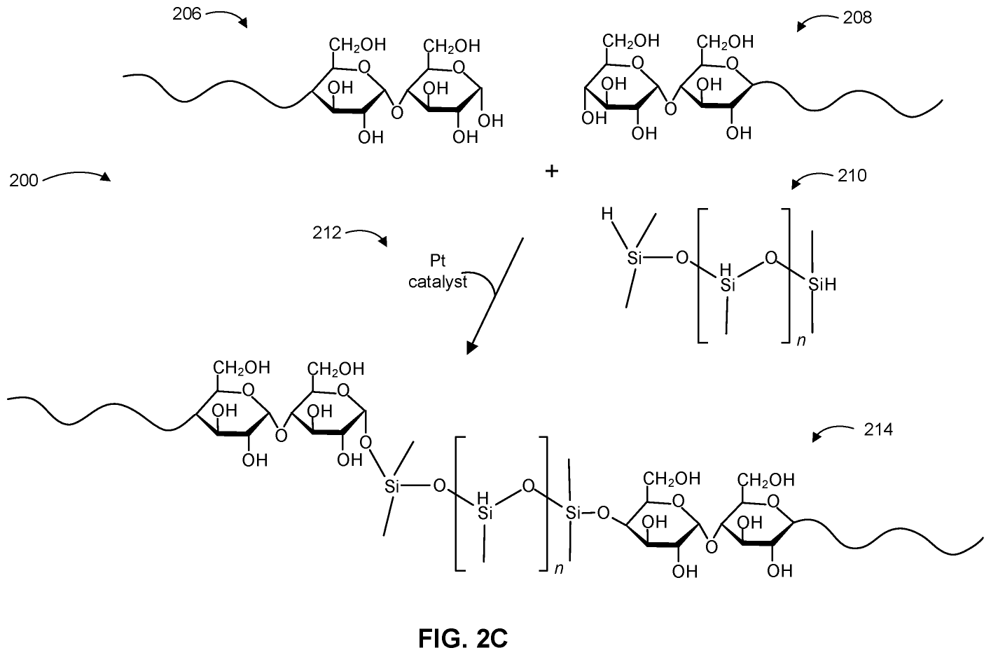

FIGS. 2A-2C depict an exemplary process of forming a polymeric network support for cellulose-lignin based material, in accordance with one illustrative inventive concept. As an option, the present method 200 may be implemented to construct structures such as those shown in the other FIGS. described herein. Of course, however, this method 200 and others presented herein may be used to form structures which may or may not be related to the illustrative inventive concepts listed herein. Further, the methods presented herein may be carried out in any desired environment. Moreover, more or less operations than those shown in FIGS. 2A-2C may be included in method 200, according to various inventive concepts. It should also be noted that any of the aforementioned features may be used in any of the inventive concepts described in accordance with the various methods.

FIG. 2A depicts a schematic drawing of a generalized structure of lignin 202 and a generalized structure of cellulose 204. Each structure has an example of a hydroxyl site (—OH) that may be reacted with silane species (see dashed circle in each drawing). FIG. 2B depicts the effects of degradation on a cellulosic material (e.g., cellulose-lignin based material). Each cellulose chain 206, 208 may have been hydrolyzed from a single chain, for example, during degradation.

FIG. 2C depicts a schematic diagram of a method 200 an exemplary example of the method 100 of forming a polymeric network support for cellulose-lignin material. A mixture of siloxane species 210 is added to hydrolyzed cellulose chains 206, 208 of degraded cellulose-lignin material. A metal catalyst of the mixture, for example a platinum (Pt) catalyst 212, catalyzes a reaction to form a siloxane-modified cellulose-lignin material 214 having a cellulose-lignin network and a network of siloxane in cross-linking bridges in the cellulose-lignin material.

In one inventive concept a product includes a cellulose-lignin material having a cellulose-lignin network and a network of siloxane in cross-linking bridges in the cellulose-lignin network. In some approaches, the modified cellulose-lignin material having a cellulose-lignin material and a network of siloxane in cross-linking bridges may allow transport a gas across the cellulose-lignin material, for example, CO₂, air, O₂, nitrogen, argon, water vapor, acetic acid, formaldehyde, etc.

In some approaches, the modified cellulose-lignin material having a cellulose-lignin material and a network of siloxane in cross-linking bridges may allow transport a mobile volatile organic compound across the cellulose-lignin material, for example, furanone, acetic acid, formaldehyde, acetaldehyde, etc. In some approaches, the modified cellulose-lignin material having a cellulose-lignin material and a network of siloxane in cross-linking bridges may allow transport water vapor across the cellulose-lignin material. Ideally, the modified cellulose-lignin material does not inhibit transport of the material thereacross significantly more than the untreated cellulose-lignin material.

In some approaches, the modified cellulose-lignin material may include an inorganic filler for strengthening the siloxane-modified cellulose-lignin material. In one approach, the inorganic filler in the siloxane-modified cellulose-lignin material includes a nanofiller, for example, nanosilica. In one exemplary approach, the inorganic filler in the siloxane-modified cellulose-lignin material includes a microfiller, for example, fumed silica microaggregates.

Optional step 108 of method 100 involves soaking the modified cellulose-lignin material in a solution that includes a base and an alcohol for hydrolyzing the siloxane species of the modified cellulose-lignin material. Step 108 may reverse the siloxane modification of the cellulose-lignin material. In some approaches, the coupling of siloxane to cellulose-lignin material may be reversed and the small molecule and oligomeric multi-silane functional siloxane species may be removed through bath treatment under mild base (e.g., a buffer having a pH 7.5 to 9.0) in propanol, isopropanol, water, ethanol, other non-polar solvents, etc. conditions at moderately elevated temperatures. In some approaches, the temperature of the solution to reverse the modification of the cellulose-lignin material may be in a range of 37° C. to 60° C., and preferably around 50° C.

In some approaches, the modified cellulose may be hydrolyzed with mild treatment to reverse the modification by the silicone. In some approaches the modification of cellulose-lignin material may be substantially reversible. In an exemplary approach, the modification of cellulose-lignin material may be up to 95% reversible, and preferably greater than 95% reversible. For example, paper modified with silicone as described may be placed in a bath of basic solution and heated for an extended period of time to fully hydrolyze the modification; for example, the modified paper may be place in a basic isopropanol bath to 50° C. for a period of at 48-120 hours. A post washing step in non-polar organic solvent, for example, toluene, chloroform, etc., may be optionally employed to remove any residual hydrolyzed siloxane species. In some approaches, a paper following reversed modification may be dried, for example, oven drying at 25-50° C. for 1-2 hours. In some approaches, the basic nature of step 108 of method 100 may not catalyze further hydrolytic degradation of the cellulose-lignin material.

Experiments

Platinum-Mediated Hydrosilylation of Cellulose-Lignin Paper

A mixture of multi-functional (silane functional) siloxanes and siloxane oligomers were dissolved in a solution of a non-polar organic solvent such as chloroform or toluene containing 10-100 ppm of Karstedt's catalyst. The total weight (wt) fraction of dissolved siloxane species was in the range of 0.1-10 wt %. The typical composition of siloxanes is 80-100% Tetrakis(dimethylsiloxy)silane, 0-10 wt % polymethylhydrosiloxane oligomers, and 0-50 wt % of bis-silane functional siloxane oligomers. The paper material was bath soaked in this solution at room temperature for 1-5 hours with pressure cycling to ensure the penetration of the reagent solution into the cellulose fibers.

The paper was then removed from the bath, hung in a forced convection oven and held at a temperature of 50-110° C. for a period of 1-12 hours to complete the modification process.

In order to reverse the modification, the modified paper was placed in a bath of 0.1-1 M KOH in isopropanol and heated to 50° C. for a period of at 48-120 hours in order to fully hydrolyze the modification. A post washing step in non-polar organic solvent such as toluene or chloroform was optionally employed to remove any residual hydrolyzed siloxane species with a final oven drying step at 25-50° C. for 1-2 hours.

In Use

Various inventive concepts described herein may be used in conservation of processed cellulose-lignin based materials of cultural and historical significance. Some inventive concepts may be useful in preservation of paper based materials (manuscripts, newspapers, other documents, fabrics, other cellulose based materials/artifacts, etc.).

Various inventive concepts described herein may improve the mechanical properties of processed cellulose-lignin materials and artifacts by remediation of degraded and otherwise fragile cellulose based natural, processed, semi-synthetic materials, etc.

The inventive concepts disclosed herein have been presented by way of example to illustrate the myriad features thereof in a plurality of illustrative scenarios, inventive concepts, and/or implementations. It should be appreciated that the concepts generally disclosed are to be considered as modular, and may be implemented in any combination, permutation, or synthesis thereof. In addition, any modification, alteration, or equivalent of the presently disclosed features, functions, and concepts that would be appreciated by a person having ordinary skill in the art upon reading the instant descriptions should also be considered within the scope of this disclosure.

While various inventive concepts have been described above, it should be understood that they have been presented by way of example only, and not limitation. Thus, the breadth and scope of an inventive concept of the present invention should not be limited by any of the above-described exemplary inventive concepts, but should be defined only in accordance with the following claims and their equivalents.

What is claimed is:

1. A product for modifying a cellulose-lignin material with siloxane, the product comprising:
a mixture, having a siloxane species, a metal catalyst, and a nonpolar solvent,
the mixture being operative to modify a cellulose-lignin material with siloxane upon wetting of the cellulose-lignin material with the mixture and subsequent drying of the cellulose-lignin material.

2. The product of claim 1, wherein an amount of the siloxane species is in a range of about 0.1 weight % to about 10 weight % of a total weight of the mixture.

3. The product of claim 1, wherein the siloxane species comprise a multi-functional siloxane and siloxane oligomers.

4. The product of claim 3, wherein the multi-functional siloxane comprises at least one siloxane selected from the group consisting of:
Tetrakis(dimethylsiloxy)silane, polymethyl hydrosiloxane, and poly(methylhydrosiloxane)-co-polydimethylsiloxane).

5. The product of claim 4, wherein an amount of Tetrakis(dimethylsiloxy)silane is in a range of about 80 weight % to about 100 weight % of total weight of the mixture.

6. The product of claim 3, wherein the siloxane oligomers comprise at least one oligomer selected from the group consisting of: a polymethylhydrosiloxane oligomer and a bis-silane functional siloxane oligomer.

7. The product of claim 6, wherein the siloxane oligomers include the polymethylhydrosiloxane oligomer, wherein an amount of polymethylhydrosiloxane oligomer is in a range of greater than 0 weight % to about 10 weight % of total weight of the siloxane species.

8. The product of claim 6, wherein the siloxane oligomers include the bis-silane functional siloxane oligomer, wherein an amount of bis-silane functional siloxane oligomers is in a range of greater than 0 weight % to about 50 weight % of total weight of the siloxane species.

9. The product of claim 1, wherein the nonpolar solvent is selected from the group consisting of: toluene and chloroform.

10. The product of claim 1, wherein an amount of the metal catalyst in the mixture is in a range of about 10 ppm to about 100 ppm.

11. The product of claim 1, wherein the metal catalyst is Karstedt's catalyst.

12. A method for modifying a cellulose-lignin material with siloxane, the method comprising:
exposing the cellulose-lignin material to a mixture comprising a siloxane species, a metal catalyst, and a nonpolar solvent to penetrate the cellulose-lignin material with the siloxane species;
removing the cellulose-lignin material penetrated with the siloxane species from the mixture; and
drying the cellulose-lignin material penetrated with the siloxane species whereby the cellulose-lignin material is modified with siloxane upon drying thereof.

13. The method of claim 12, wherein an amount of siloxane species is in a range of 0.1 weight % to about 10 weight % total weight of the mixture.

14. The method of claim 12, wherein the siloxane species comprise a multi-functional siloxane and siloxane oligomers.

15. The method of claim 14, wherein the multi-functional siloxane comprises at least one siloxane selected from the group consisting of:
Tetrakis(dimethylsiloxy)silane, polymethyl hydrosiloxane, and poly(methylhydrosiloxane)-co-polydimethylsiloxane).

16. The method of claim 14, wherein an amount of multi-functional siloxane is in a range of about 80 weight % to about 100 weight % of total weight of the mixture.

17. The method of claim 14, wherein the siloxane oligomers comprise at least one oligomer selected from the group consisting of: a polymethylhydrosiloxane oligomer and a bis-silane functional siloxane oligomer.

18. The method of claim 17, wherein the siloxane oligomers include the polymethylhydrosiloxane oligomer, wherein an amount of polymethylhydrosiloxane oligomer is in a range of greater than 0 weight % to about 10 weight % of total weight of the siloxane species.

19. The method of claim 17, wherein the siloxane oligomers include the bis-silane functional siloxane oligomer, wherein an amount of bis-silane functional siloxane oligomers is in a range of greater than 0 weight % to about 50 weight % of total weight of the mixture.

20. The method of claim 12, wherein the nonpolar solvent is selected from the group consisting of: toluene and chloroform.

21. The method of claim 12, wherein the metal catalyst initiates a transition metal-mediated hydrosilylation reaction between the siloxane species and the cellulose-lignin material.

22. The method of claim 12, wherein an amount of the metal catalyst in the mixture is in a range of about 10 ppm to about 100 ppm.

23. The method of claim 12, wherein the metal catalyst is Karstedt's catalyst.

24. The method of claim 12, wherein the modification of the cellulose-lignin material is substantially reversible.

25. The method of claim 24, comprising:
soaking the modified cellulose-lignin material in a solution comprising a base and an alcohol for hydrolyzing the siloxane species of the modified cellulose-lignin material.

26. The method of claim 25, wherein the alcohol is isopropanol.

27. The method of claim 12, wherein an inorganic filler is added to the mixture.

28. The method of claim 27, wherein an amount of the inorganic filler added to the mixture is in a range of about 1 weight % to about 10 weight % of a total weight of the mixture.

29. A product, comprising:
a siloxane-modified cellulose-lignin material having a cellulose-lignin network and a network of siloxane in cross-linking bridges in the cellulose-lignin network.

30. The product of claim 29, wherein the product allows transport across the siloxane-modified cellulose-lignin material of at least one material selected from the group consisting of: a gas, a mobile volatile organic compound, and water vapor.

31. The product of claim 29, comprising an inorganic filler for strengthening the siloxane-modified cellulose-lignin material.

32. The product of claim 31, wherein the inorganic filler is selected from the group consisting of: fumed silica microaggregates and nanosilica.
